(19) United States
(12) Patent Application Publication
(10) Pub. No.: US 2016/0029115 A1
(43) Pub. Date: Jan. 28, 2016

(54) Background of the invention

(71) Applicant: Wen Hong Shen, Taipei (TW)

(72) Inventor: Wen Hong Shen, Taipei (TW)

(21) Appl. No.: 14/121,073

(22) Filed: Jul. 28, 2014

(51) Int. Cl. H04R 1/10

(52) U.S. Cl. CPC H04R 1/1083; H04R 1/1016; H04R 1/105; H04R 2460/11

(57) ABSTRACT

An earphone includes an earphone body electrically connectable to sound source means, and a rubber plug member mounted at a front coupling rod of the earphone body and including a front end part adapted for insertion into the external auditory canal of the user's ear and a rear end part shaped like a set of petals or perforated flying disc and radially outwardly extended from the rear side of the front end part.

### BACKGROUND OF THE INVENTION

1. Field of the Invention:

The present invention relates to in-ear earphone technology and more particularly, to an earphone, which has a rubber plug member mounted at the front side of the earphone body thereof and insertable with a radially outwardly extended rear part into the external auditory canal of the user's ear to enhance positioning stability and to effectively isolate outside noises.

2. Description of the Related Art:

With the development of multimedia technology, various multimedia devices have been created and appeared on the market. In consequence, In-ear earphones and headphones are widely used with mobile multimedia devices. An in-ear earphone can be directly inserted into the external auditory canal of the ear and positioned therein by means of friction resistance. However, conventional in-ear earphones are not adjustable to fit the configurations of different external auditory canals, resulting in wearing discomfort and low level of noise isolation.

### SUMMARY OF THE INVENTION

The present invention has been accomplished under the circumstances in view. It is one object of the present invention to provide an earphone, which has a rubber plug member mounted at the front side of the earphone body thereof and insertable with a radially outwardly extended rear part into the external auditory canal of the user's ear to enhance positioning stability and to effectively isolate outside noises.

To achieve this and other objects of the present invention, an earphone comprises an earphone body electrically connectable to sound source means and having a coupling rod located at a front side thereof, and a rubber plug member mounted at the coupling rod of the earphone body for insertion into the external auditory canal of a user's ear. The plug member comprises a front end part adapted for insertion into the external auditory canal, and a rear end part located at a rear side of the front end part and shaped like a set of petals or perforated flying disc and radially outwardly extended from the rear side of the front end part.

### BRIEF DESCRIPTION OF THE DRAWINGS

FIG. 1 is an exploded view of an earphone in accordance with a first embodiment of the present invention.

FIG. 2 is a sectional side view of the earphone in accordance with the first embodiment of the present invention.

FIG. 3 is an elevational view of an earphone in accordance with a second embodiment if the present invention.

FIG. 4 is an exploded view of the earphone in accordance with the second embodiment of the present invention.

FIG. 5 is a sectional side view of the earphone in accordance with the second embodiment of the present invention.

### DETAILED DESCRIPTION OF THE PREFERRED EMBODIMENT

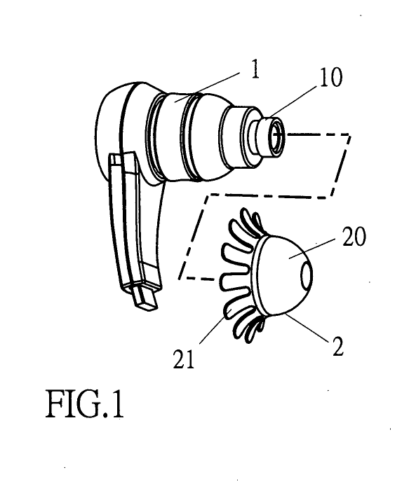

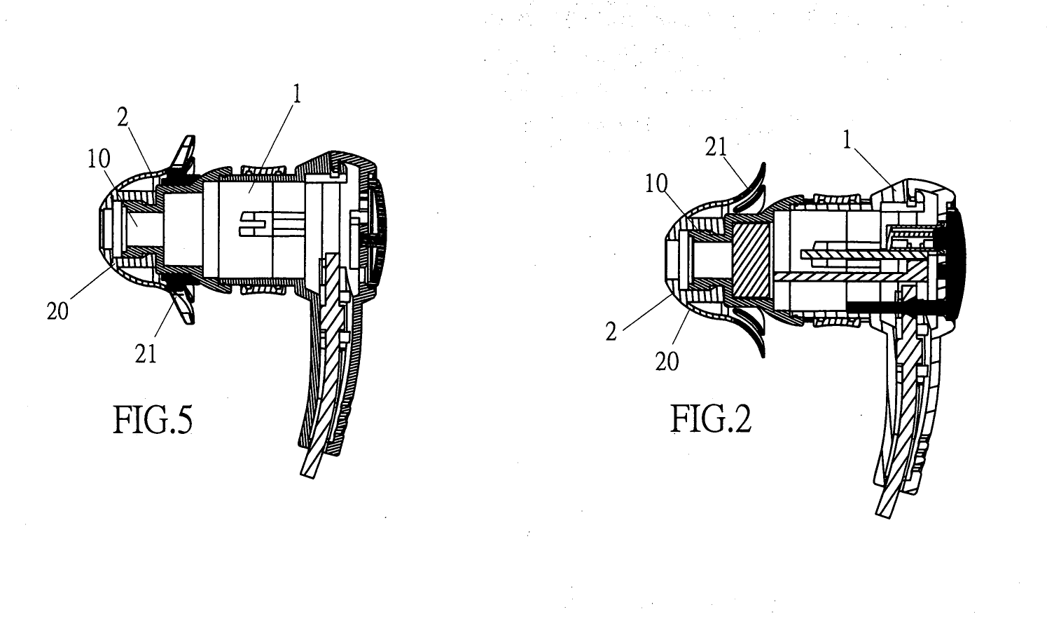

Referring to FIGS. 1 and 2, an earphone in accordance with a first embodiment of the present invention is shown. The earphone comprises an earphone body 1 electrically connected to sound source means (not shown) and having a coupling rod 10 located at a front side thereof, and a rubber plug member 2 mounted at the coupling rod 10 of the earphone body 1 for insertion into the external auditory canal of one ear of the user. The plug member 2 comprises a front end part 20 adapted for insertion into the external auditory canal, and a rear end part 21 located at a rear side of the front end part 20 and shaped like a set of petals or perforated flying disc.

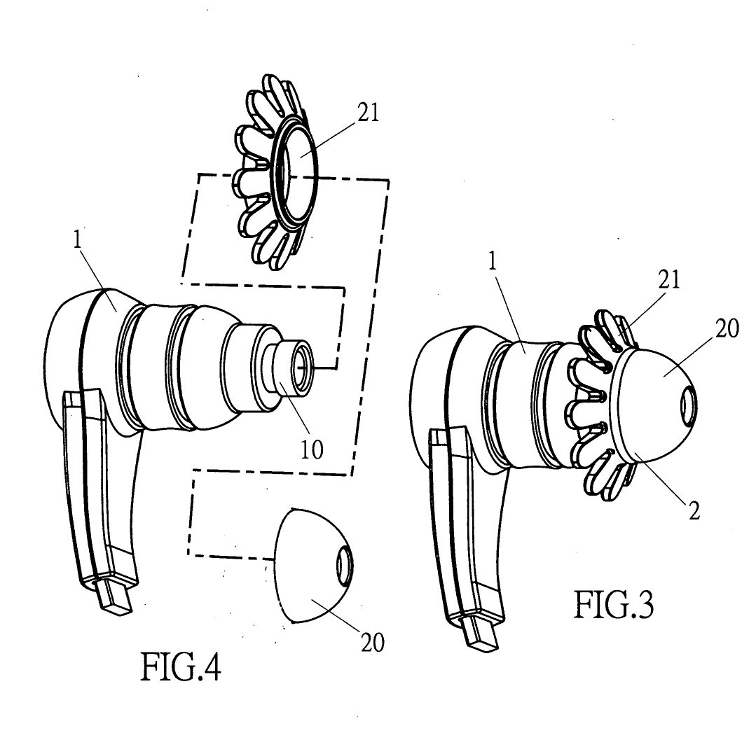

In a second embodiment of the present invention, as shown in FIGS. 3-5, the front end part 20 and rear end part 21 of the rubber plug member 2 are two independent members separately made and then detachably fastened together.

With the elastically deformable material property, the rubber plug member 2 can be detachably press-fitted onto the coupling rod 10 of the earphone body 1. Further, the rear end part 21 extends radially outwardly from the rear side of the front end part 20 to increase the friction force between the rubber plug member 2 and the user's ear after insertion of the front end part 20 into the external auditory canal of the user's ear, enhancing the positioning stability of the earphone in the external auditory canal and its functioning to isolate external noises.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An earphone, comprising:
an earphone body electrically connectable to sound source means, said earphone body comprising a coupling rod located at a front side thereof; and
a rubber plug member mounted at said coupling rod of said earphone body for insertion into the external auditory canal of a user's ear, said plug member comprising a front end part adapted for insertion into the external auditory canal, and a rear end part located at a rear side of said front end part and shaped like a set of petals or perforated flying disc and radially outwardly extended from the rear side of said front end part.

2. The earphone as claimed in claim 1, wherein said front end part and said rear end part of said rubber plug member are two independent members separately made and then detachably fastened together.
